(19) United States
(12) Patent Application Publication
(10) Pub. No.: US 2025/0371194 A1
(43) Pub. Date: Dec. 4, 2025

(54) AUTHENTICATION AND VERIFICATION OF USER DATA USING BLOCKCHAIN-BASED POINTER RECORDS

(71) Applicant: Nexum Captial Inc., Athens (GR)

(72) Inventor: Konstantinos Vonatsos, Athens (GR)

(21) Appl. No.: 18/918,354

(22) Filed: Oct. 17, 2024

(30) Foreign Application Priority Data
Jun. 4, 2024 (EP) 24386066.5

(51) Int. Cl. G06F 21/62; G06Q 20/36; H04L 9/00

(52) U.S. Cl. CPC G06F 21/6263; G06Q 20/363; H04L 9/50; G06Q 2220/10

(57) ABSTRACT

Method and apparatus for protecting confidential user data associated with a User. The user data are partitioned into portions which are stored in different memory locations, each portion insufficient to facilitate reconstruction of personally identifiable information without use of each of the remaining portions. A storage address for at least one portion is encoded and incorporated into a minted non-fungible asset (NFA) recorded to a distributed blockchain and placed in a User digital wallet. To subsequently reconstruct and access the user data, the storage address from the NFA is decoded, and the portions are retrieved from memory and recombined. A secure communication link facilitates authorized access to the reconstructed user data. Main and associated wallets may be used to track original and updated NFAs. The storage address may be in the Interplanetary File Storage (IPFS) system. The user data may be destroyed by erasing at least one portion from memory.

### RELATED APPLICATIONS

The present application makes a claim of priority under 35 U.S.C. 119(a) to co-pending European Patent Application No. 24386066.5 filed Jun. 4, 2024, the contents of which are hereby incorporated by reference.

### BACKGROUND

Electronic financial transactions are subject to a number of regulatory requirements to reduce the incidence of fraud, illicit transfers, identity theft, and other criminal or prohibited actions. Such regulatory requirements are usually implemented and enforced at a governmental or international regulatory level, and can include Anti-Money Laundering (AML) regulations, Customer Due Diligence (CDD) procedures, and Know Your Client (KYC) protocols. These and other requirements attempt to curb illicit transfers associated with underlying crimes and prohibited activities by verifying the identities of parties and the provenance of funds prior to engaging in online business transactions.

At the same time, the protection of personal privacy of natural persons within a digital data ecosystem is paramount and is subject to ever increasing regulatory oversight. For example, the European Union and the UK ensure the protection for, and the free movement by the user of, personally identifiable digital data among these member states through the so-called General Data Protection Regulation (GDPR) and other regulatory requirements. The United States provides for the protection of confidential personal data in a variety of contexts including through the Health Insurance Portability and Accountability Act (HIPAA), the Fair Credit Reporting Act (FRCA), the Family Education Rights and Privacy Act (FERPA), the Gramm-Leach-Bliley Act (GLBA), the Electronic Communications Privacy Act (ECPA), the Federal Trade Commission Act (FTCA), and many others. Other countries throughout the world have enacted similar protections for personally identifiable user information of individuals.

The continued advancements in digital communication and processing technology make it increasingly difficult for reputable business concerns to fully comply with these respective financial reporting and privacy protection requirements. This is particularly the case for transactions within the global financial system where overlapping, and even conflicting, regulatory requirements may govern the transactions. There accordingly remains an ongoing need for improvements in the manner in which these and other requirements can be efficiently and effectively satisfied.

### SUMMARY

Various embodiments of the present disclosure are generally directed to systems and methods for protecting and using confidential user data in a digital environment.

Without limitation, some embodiments operate to partition the user data into portions that are respectively stored in memory, with each portion being insufficient to facilitate reconstruction of personally identifiable information for the user without use of each of the remaining portions. At least one storage address for the portions is encoded to provide encoded address information which is included in a blockchain-based pointer record associated with the User and recorded to a distributed blockchain. In response to a request for access to the user data by an authorized party, the blockchain-based pointer record is accessed, the storage address is decoded, and the portions are retrieved from memory to reconstruct the originally presented user data. A secure communication link is used to facilitate access by the authorized party of the reconstructed user data.

These and other features and advantages of various embodiments can be understood from a review of the following detailed description in conjunction with the accompanying drawings.

### BRIEF DESCRIPTION OF THE DRAWINGS

FIG. 1 is a functional block representation of an information handling environment utilized by various primary entities to engage in one or more transactions in accordance with various embodiments of the present disclosure.

FIG. 2 depicts various secondary entities that may utilize additional aspects of the information handling environment of FIG. 1 in accordance with some embodiments.

FIG. 3 is a functional block representation of an information handling system implemented within the environment of FIG. 1 in some embodiments.

FIG. 4 depicts a blockchain-based pointer record in the form of a user ID wallet that communicates with one or more blockchains and stores a user ID non-fungible token (NFT) constructed and operated in accordance with some embodiments.

FIG. 5 is a sequence flow diagram illustrating operation of aspects of the system of FIG. 3 to generate user data in accordance with some embodiments.

FIG. 6 is a functional block diagram of further aspects of the system of FIG. 3 to mint the user ID NFT of FIG. 4 and store the user data of FIG. 5 in some embodiments.

FIGS. 6A, 6B and 6C respectively show additional details of the operation of circuitry in FIG. 6 in accordance with further embodiments.

FIG. 7 is an exemplary format for the user ID NFT in accordance with some embodiments.

FIG. 8 is a sequence flow diagram illustrating subsequent operation of further aspects of the system of FIG. 3 to grant authorized access to the user data stored in FIG. 6 in some embodiments.

FIG. 9 is a functional block representation of an exemplary manner in which the user data can be generated and accessed in some embodiments.

FIG. 10 is a functional block representation of an exemplary manner in which the user data is further processed and stored in some embodiments.

FIG. 11 depicts an exemplary data partitioning operation carried out upon the user data in some embodiments.

FIG. 12 is a functional block representation of partitioning circuitry configured to carry out partitioning such as in FIG. 11 in some embodiments.

FIG. 13 provides a functional block representation of an exemplary manner in which the stored user data can be retrieved and accessed by an authorized user.

FIG. 14 provides a transaction processing routine carried out in accordance with further embodiments.

FIG. 15 shows a user data deletion routine carried out in accordance with still further embodiments.

FIG. 16 is a functional block representation of a Data Provider (DP) controller circuit constructed and operated in accordance with further embodiments.

FIG. 17 shows the use of various types of wallets including main wallets and associated wallets in accordance with further embodiments.

FIG. 18 illustrates different types of NFTs that can be minted in accordance with further embodiments.

FIG. 19 is a sequence diagram illustrating the manner in which a user may obtain an updated wallet configuration using the elements of FIGS. 17-18 in further embodiments.

FIG. 20 shows a reconstructed ownership history for a selected wallet in accordance with further embodiments.

FIG. 21 shows a history chain for a selected wallet established by the various types of NFTs represented in FIG. 18 in some embodiments.

FIGS. 22A, 22B and 22C show respective exemplary formats for the NFTs in FIG. 18 in further embodiments.

FIG. 23 shows an access operation carried out in accordance with further embodiments.

### DETAILED DISCUSSION

Various embodiments of the present disclosure generally provide an apparatus and method for processing and protecting confidential user data through the use of one or more blockchain-based pointer records arranged to provide user identification (UID) digital verification. While not limiting, the blockchain-based pointer records may take the form of non-fungible assets (NFAs), such as user ID non-fungible tokens (NFTs) stored in specially configured digital wallets.

As explained below, the system provides an operational environment in which different entities can safely and efficiently exchange information in a manner that complies with all existing and future implemented regulatory requirements. While the various embodiments are of particular value in the context of an international business transaction, such is merely illustrative and is not limiting. Rather, the various embodiments presented herein can be implemented in any number of different operational environments to comply with any number of different regulatory schema and/or other system requirements. To this end, reference to a “transaction” includes a financial transaction of the type where value is exchanged for goods and/or services, but is not so limited; more broadly, the term “transaction” will be understood as any type of informational exchange for any lawful purpose as mediated by the various embodiments herein.

The system can utilize a number of digital elements including NFTs, digital wallets, cryptocurrency, blockchain, cloud computing and storage services, cryptography, storage containers, web services, artificial intelligence (AI) and machine learning (ML) systems, and others. However, the system is not so limited, nor are all of these elements necessarily required in every or any implementation.

To provide an overview in the form of a non-limiting embodiment, it will be initially contemplated that a first entity (party), sometimes referred to herein as the User, desires to engage in a transaction with a second entity, sometimes referred to herein as the Servicer. A third entity, sometimes referred to herein as the Data Provider, mediates aspects of the transaction, including the protection and provision of confidential user data associated with the User.

The User may be a natural person, a corporation, or some other entity that desires to enter into a transaction with the Servicer. While not limiting, it many cases the Servicer will be a supplier of goods and/or services desired by the User. The Data Provider is a standalone entity with cryptographic and data storage capabilities. The User, Servicer and Data Provider are sometimes referred to as primary entities in this scheme. A number of secondary entities may further be involved on an as-needed basis.

The User has certain personal, confidential and/or proprietary information (hereinafter “user data” or “user ID data”) corresponding to or otherwise associated with an individual (natural person). The user data are processed by the system in such a way that the information is verified in accordance with the applicable due diligence requirements and protected in compliance with the applicable data privacy requirements. The data are stored by the Data Provider and, under limited and controlled conditions, made available to the Servicer and/or the User to enable both parties to comply with both types of requirements. The Data Provider itself does not own or retain the user data.

The user data can take any form of public or private data associated with the User, including but not limited to personal data (e.g., name, address, banking information, etc.), certificates issued to the user (e.g., governmental IDs, diplomas, credential documents, etc.), background investigation data performed by a third party upon the user, information from governmental databases, etc., and so on. The user data can be a single document, an entire set of both user supplied data and third party investigation data, or anything in between. In terms of size, the user data can be any size from (potentially) a single bit of data or a few bytes of data to many megabytes or gigabytes of data or more. The user data can be in any computer-based form including text, images, video files, audio files, database data, barcodes, programs, objects, etc. or any combination thereof as well as other formats.

As explained more fully below, some embodiments implement a digital wallet for the User to link blockchain addresses for the user data, which is generated upon the individual being subjected to an identity verification (IDV) procedure. The IDV procedure may be undertaken by a secondary entity such as a KYC Provider that has been appointed by the Servicer responsive to an application to the Servicer by the User.

As noted above, the Servicer may have certain obligations such as under various anti-laundering regulations (hereinafter “Money Laundering Regulations” or “MLR”) to undertake CDD prior to transacting with the User in order to properly understand and verify the identity of the User. It will be noted that in many jurisdictions, there is a requirement to retain the records of these procedures; for example, the UK requires a data retention period of five (5) years from the date of cessation of the relationship with the User. Other jurisdictions may have similar requirements.

The digital wallet developed under this system, sometimes referred to herein as the “User ID Wallet” or simply the “Wallet,” addresses a number of issues related to transparency and compliance related to transfers of and transactions in digital assets. Among other things, the Wallet allows the User to prove that the identity of the individual has already been properly verified at the time that the User seeks to use the platform of a new Servicer.

If the Wallet has an existing identity verification confirmation, and if the Servicer has agreed to accept that identify verification, the User can access a platform of the Servicer such as by logging into a control panel feature (application, app) of the Wallet (the “Portal”) or by logging directly into the website/application of the Servicer via a web portal or similar. If the User does not have an existing identity verification that is accepted by the Servicer, the User can be directed to perform a new IDV process via the Portal. Upon successful completion of the IDV process, the system mints a User ID NFT to evidence the successful completion of the IDV process. The User ID NFT can be read by any Servicer having access to the system (such as through the use of a smart contract), allowing the Servicer to validate the User's verification status.

While not limiting, some embodiments provide multiple types, or levels, of User ID NFTs. These can include an Identity Verification NFT (“IDV NFT”), which provides basic information such as name, date of birth (DOB), etc. An Address Verification NFT (“ADV NFT”) adds additional information such as address, residency history, etc. An AML Verification (“AML NFT”) provides yet additional information required by at least certain regulatory requirements such as source of funds, etc. Other forms of NFTs may be minted, so the foregoing are merely exemplary and are not limiting. The Data Provider operates to mint the NFT(s) and place the same into the Wallet for the User.

As noted above, the Data Provider is not the owner of the user data. Instead, the user data belong to the User. The user data include both a first portion supplied by the User initially to initiate the IDV process (this user supplied data is sometimes referred to below as CDD data, CDD documents, etc.), and a second portion obtained by the KYC Provider in performing the investigation and background check verification (this KYC Provider data corresponds to the KYC Report).

In at least some jurisdictions (e.g., under the GDPR, etc.), the Servicer may become a Data Controller upon acceptance of engagement with the User, which provides specific obligations under the MLR to obtain, verify and store the requisite information relating to the User's identity. It may be necessary for the Servicer and the KYC Provider to execute a contractual arrangement in order to specify and agree upon the nature and extent of identity verification procedures required.

Such a contractual arrangement appears to be mandated by current UK MLR when an entity makes use of an outsourced KYC Provider, and under those regulations the Servicer retains responsibility for ensuring the adequacy of the CDD procedures, taking into account its obligations under the MLR and its own policies and procedures in relation to CDD (including the determination of when enhanced due diligence (“EDD”) procedures are required). Separately, the Servicer and the Data Provider may enter into a separate contractual arrangement in which the Data Provider operates under the color of law as a Data Processor on behalf of the Servicer (Data Controller) with respect to the user data. Depending upon the jurisdiction, there are certain regulatory requirements placed upon a Data Processor with regard to the control of the user data, including the retention, deletion and provision of the user data as directed by express instructions by the Data Controller in accordance with all regulatory requirements.

When the IDV processing is performed, the User first submits the required information (e.g., the CDD data and documents) to the designated KYC Provider which also acts as a Data Processor. The KYC Provider is instructed by the Servicer (as Data Controller) to perform the IDV procedures upon the individual associated with the User and to summarize the results of those procedures, including the User's relevant identity details, in a document evidencing the completion of the procedures (the aforementioned KYC Report). The KYC Provider is also required to provide the underlying evidence provided by the User (the aforementioned CDD data and documents) to the Servicer. This instruction will be documented in the contractual arrangements between the Servicer and the KYC Provider.

With regard to the operation of the system which will be described more fully below, once the user data has been accumulated by the KYC Provider (e.g., originally supplied CDD data/documents and the associated KYC Report), the user data are securely transferred to the Data Provider under one or more levels of cryptographic protection. In at least some embodiments, the Data Provider operates to separate the received user data into multiple components (portions). The respective components are stored in separate storage locations in separate storage systems, such as a local storage system and a remote storage system.

Without limitation, some embodiments operate to partition (divide) the user data into a plurality of portions (components), each separately including a portion of the overall user data. Some embodiments use two (2) components, the first referred to as an AWS (Amazon Web Services) Component and the second referred to as an IPFS (Interplanetary File System) Component. The AWS Component is stored locally to AWS servicers under the control of the Data Provider (in some cases care may be taken to ensure that the AWS servers are in the same jurisdiction as the Data Provider). The IPFS Component is stored remotely in the IPFS. Other configurations can be used, including different numbers of components, different types, configurations and locations of the local/remote storage, etc.

As noted previously, the use of AWS and IPFS are merely illustrative and are not limiting. Rather, the respective components can be more generally viewed as being stored in at least different first and second storage locations. The first and second storage locations may be viewed as local storage (e.g., under direct control of the owner of the data with regard to where the data are stored within the system) and/or remote storage (e.g., not under direct control of the owner of the data with regard to where the data are stored within the system). Local storage does not necessarily require the storage devices be on premises, but it does provide sufficient control such that all copies of the data stored by the local storage system can be affirmatively deleted from the system in response to a data deletion command.

The relative division of these respective components will vary depending on the requirements of a given application. However, such partitioning is carried out in at least some embodiments such that no personally identifiable information can be reconstructed by a single component; that is, both (or all) components are required to be brought together and decoded using suitable reconstruction processing in order to recover the user data. In isolation it could thus be said that neither the AWS Component nor the IPFS Component represents personal data of any User (because the KYC Reports and underlying CDD Documents cannot be reconstructed from only one of the files). At the same time, the user data may not be considered permanently destroyed/deleted because it can be reconstructed by the Data Provider using its access to both files, for as long as all of the independent parts exist.

At this point it will be noted that, depending on the requirements of a given application, some or all of the user data may also be stored directly by the Servicer, such as on its own servers. Even if the requirements do not permit the storage of the user data (or a portion thereof) in certain locations (such as the IPFS, outside a given jurisdiction, etc.), the use of the User ID NFT can still provide an opportunity to enhance data security and reduce cost of storage by storing at least some portions of the user data therewith.

No personally identifiable information is stored in the User ID NFT. However, certain classification type data may be provided in encrypted or unencrypted form, such as the type of NFT, the type of entity (e.g., whether the User is an individual, a corporation, etc.), the tax residence of the User, a unique User ID value, etc. Other data that are specifically provided in protected form (e.g., encrypted) can include the existence and status of a KYC report, the number of times the report has been accessed, other relevant members/NFTs for related parties, and so on. In at least some embodiments, the User ID NFT further may include, in protected form, the link address(es) related to the stored component(s) of the user data, such as but not limited to an encoded IPFS address at which the component may be retrieved.

The protected data in the User ID NFT is not immediately available to the Servicer (or User, or any other party) when the NFT is read. Instead, these data can be requested from the Data Provider. In practice, the Servicer should consider whether the information immediately available is sufficient for its needs. As noted previously, the Servicer may be obligated under MLR requirements to obtain information relating to the User's identity prior to commencing a business relationship with the User. This information can be made available to the Servicer by requesting the underlying KYC Report from the Data Provider. In some cases, a Servicer may have a preference to be able to read this information directly from the NFT, or to obtain the KYC Report and CDD Documents and store them on their own behalf. As such, the actual protected and unprotected data in the User ID NFT can be tailored to the requirements of a given situation, provided all applicable regulatory requirements are met.

In the case where the Servicer seeks access to the KYC Report and CDD Documents (for example to obtain details of the User's identify, or if the Servicer intends to store the KYC Report and CDD Documents on its own servers), the user data are reconstructed by the Data Provider. While this is discussed in greater detail below, these actions include the recovery of the locations at which the respective components are stored, reconstituting the original user data (e.g., files, objects, data sets, etc.), and making these reconstructed user data available via a secure channel, such as via a temporary link, to the Servicer.

It is presumed that, in at least most cases, the Servicer has the right to access the entirety of the recovered user data. However, in those cases where the Servicer only has access to a restricted portion of the data (e.g., “Servicer entitled data”), the Data Provider will establish the link in such a way that only the Servicer entitled data are accessible by the Servicer.

Similarly, the User will usually have an unrestricted right to access at least certain aspects of the data (the “User entitled data”), such as the originally supplied CDD data/documents etc. However, the User may not have an unrestricted right to other portions of the user data, such as the KYC Report, etc. As before, the Data Provider will establish a temporary link in such a way that only the User entitled data are accessible by the User. In all cases, the links will be temporary, monitored, protected, and will be terminated either immediately upon use, end of the session, or after a short specified period of time. While the user data will be reconstituted, it will remain in a protected area of memory (e.g., the AWS servers, etc.) and will not be separately accessed by the Data Provider to the extent possible.

The Servicer may have an unconditional right to demand access to the user data (e.g., the underlying CDD data/documents and KYC Report) without prior approval of the User in order to comply with the pertinent MLR regulations. This right may be specified in the contractual arrangements between the Servicer and the User, the Servicer and the KYC Provider, and the Servicer and Data Provider.

As such, the foregoing exemplary and non-limiting operations can be summarized including as follows:
1. The User submits the relevant evidence for the individual (name, address, DOB etc.) to the KYC Provider (the “CDD Documents”) for IDV processing.
2. The KYC Provider completes the process and prepares a report summarizing the results, including the relevant User personal details (the “KYC Report”).
3. The KYC Provider transfers the CDD Documents and the KYC Report to the Data Provider.
4. The Data Provider performs the following actions:
   a. Temporarily stores the CDD Documents and KYC Report on its local storage (such as but not limited to an AWS Server).
   b. Separates the files into a number of separate encrypted components (two (2) in this example), neither of which represents any identifiable User personal information.
   c. Stores the first component in local storage (e.g., AWS Server).
   d. Stores the second component in remote storage (e.g., IPFS Server).
   e. Determines a link address for at least the remote storage location.
   f. Mints an NFT that can be accessed by the Servicer via the Portal which displays the KYC status of the User, the NFT including the link address(es) of at least the remotely stored component(s).
   g. Transfers the minted NFT to a Wallet of the User.
5. When (and only when) requested by the Servicer or by the User in an authorized manner, the Data Provider retrieves the two components (using the embedded link address information from the NFT), temporarily stores the reconstructed user data, provides a link to the User or the Servicer to access the reconstructed files. The link is terminated immediately thereafter as described above.
6. The user data may remain available for authorized access over a predetermined period of time, such as required by certain MLR requirements (e.g., 5 years, etc.). At the end of such period, or in response to an authorized request or order to delete the files, the user data are deleted from the system, such as through the deletion of access to at least one of the stored components, thereby ensuring the user data cannot be successfully recovered.

It will be noted that the Data Provider does not maintain a copy of the user data, and yet has the capability, under controlled and authorized circumstances, to reconstruct it and make it available for other authorized parties. While the Data

Provider may have the technical capability of reconstructing the user data at substantially any time, the Data Provider may be prohibited from doing so, both from a contractual and a regulatory basis. Further layers of protection are contemplated and discussed below, such as configuring the embedded address(es) in the NFT such that the address(es) cannot be decoded without cooperation by both the Data Provider and the requesting party.

For example, the address may be encrypted in such a way that the Data Provider cannot separately decode it without the Servicer previously unlocking it for the Data Provider after the Servicer accesses the NFT. Similarly, the Data Provider may be required to apply a first level of decoding of the address information before providing that partially decoded information to the requesting party, which then fully unlocks and provides the address information to the Data Provider. In this way, the Data Provider can be said to both store, and not store, the user data in compliance with all competing regulatory and/or contractual requirements.

The foregoing scheme is not necessarily limited to a single Servicer. In some cases, a User may have an existing User ID NFT evidencing IDV status that it obtained when accessing the platform of a first Servicer (“Servicer 1”). The User may subsequently seek to access the platform of a different, second Servicer (“Servicer 2”). At that time, Servicer 2 would consider whether or not to accept the existing NFT that was minted when the User was taken on by Servicer 1, or whether it requires the User to undergo new/additional CDD procedures.

If Servicer 2 agrees to accept the existing IDV status without further KYC procedures, to comply with the MLR and other regulatory requirements, Servicer 2 may be required to enter into a contractual arrangement with the relevant KYC Provider (under which it is agreed that the KYC Provider permits the use of the original KYC Report and CDD Documents by Servicer 2). Servicer 2 would also enter a contractual arrangement with the Data Provider under which it instructs the Data Provider to hold the KYC Report and CDD Data/Documents for Servicer 2 and make the data available to Servicer 2 when demanded. Finally, the User's agreement with Servicer 2 may be drafted to specify that the User was obligated to provide KYC information to Servicer 2, but that it would be acceptable for existing KYC information as protected by the User ID Wallet could be used.

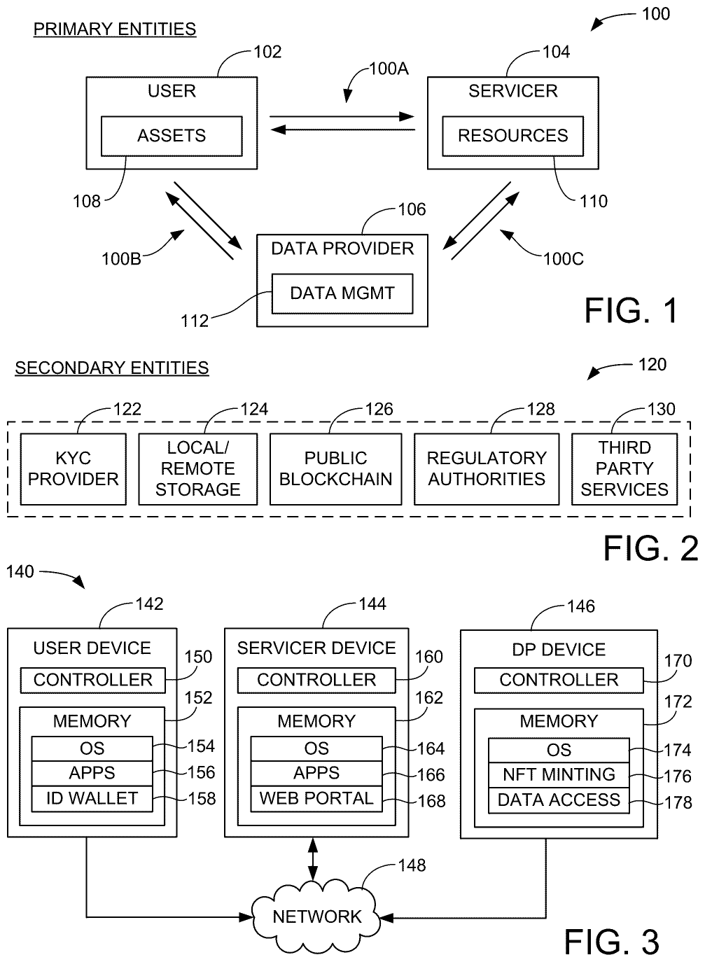

These and various other features and advantages can be understood beginning with a review of FIG. 1, which generally depicts an information handling environment 100 utilized by various primary entities 102, 104, 106 to engage in one or more transactions in accordance with various embodiments of the present disclosure. The primary entities include a User 102, a Servicer 104 and a Data Provider 106.

As noted above, the User may be an individual, a corporation, etc., but regardless has some individual (natural person) with human agency to engage in the transaction. The Servicer 104 may be a provider of goods and/or services desired by the User 102, and the Data Provider 106 is a management entity that manages user data associated with the individual associated with the User. To this end, the User 102 may have a number of assets 108; the Servicer 104 may have a number of available resources 110; and Data Provider 106 has data management circuitry 112.

As noted above, the term “transaction” is used broadly to describe substantially any form of exchange between the User and Servicer. To provide a concrete example to facilitate the following detailed discussion, assume that the User 102 is a shipping company in the commercial shipping industry which operates one or more commercial transport ships that transport cargo throughout the world. The Servicer 104 has access to funds (payroll), supplies (food), fuel and other resources that may be required by the User.

Because shipping contracts are often arranged such that payment for transport does not occur until the ship reaches the destination port and unloads the transported cargo, the arrangement(s) contemplated in this example may include the extension of currency or the provision of tangible resources to the ship at intermediate stops before reaching the destination port to enable the ship to complete its journey. These types of arrangements are commonly employed, and the various embodiments of the present disclosure are particularly suited to such. Nevertheless, it will be appreciated that this concrete example involving the commercial shipping industry is merely illustrative and is in no way limiting to the scope of the present disclosure which can be extended for use in substantially any transactional environment.

As a part of the operation of various embodiments, various digital information exchanges will necessarily be carried out, including between the User 102 and the Servicer 104 (exchanges 100A); between the User 102 and the Data Provider 106 (exchanges 100B); and between the Servicer 104 and the Data Provider 106 (exchanges 100C). To save excessive repetition, it will be understood that these and other types of digital data exchanges may be facilitated via one or more computer networks including wireless, wired, satellite, LAN, the Internet, etc. using substantially any suitable protocols and formats. Such communications can further be negotiated using substantially any type of suitable network accessible devices including but not limited to smartphones, tablets, laptop computers, desktop computers, workstations, gaming consoles, servers, edge computing devices, cloud computing devices, terminals, etc. with one or more programmable processors executing appropriate programming in the form of software, firmware, software applications, etc.

FIG. 2 depicts various secondary entities (collectively “120”) that may utilize additional aspects of the information handling environment 100 of FIG. 1 in accordance with some embodiments. These secondary entities 120 may include a KYC Provider 122, both local and remote storage services 124, one or more public ledger (or private) blockchains 126, various industry, governmental and other regulatory authorities 128, and a number of third party service providers 130.

As noted above, the KYC Provider 122 can be engaged by the Servicer 104 to perform IDV processing for the User 102 and provide the same to the Data Provider 106. The local/remote storage 124 can include, but are not limited to, various service providers including AWS and the IPFS. The public blockchain 126 can be the Ethereum® blockchain or some other blockchain with the capability of managing the User ID NFT and exercising smart contracts that interface therewith. Other forms of blockchains can be established, however, including one specifically generated by the Data Provider 106 or some other party for purposes described herein.

The regulatory authorities in the present shipping example include all applicable national and international shipping regulations, laws and requirements associated with the operations of the User 102. The third party service providers 130 can include oil companies that supply diesel fuel or other supplies to the ship en-route, etc.

FIG. 3 provides a generalized functional block representation of an information handling system 140 implemented within the environment 100 of FIG. 1 in some embodiments. The system 140 includes a user device 142 utilized by the User 102, a servicer device 144 utilized by the Servicer 104, and a data provider (DP) device 146 utilized by the Data Provider 106. Other arrangements and configurations can be used. It will be noted that each of these respective devices 142, 144, 146 communicate via an intervening network 148.

The user device 142 includes a controller 150 (e.g., one or more processors) and associated memory 152 in which are stored an operating system (OS) 154, one or more apps 156 and a User ID Wallet 158. The other devices are similarly configured: the servicer device 144 has a controller 160 and memory 162 with OS 164, apps 166 and at least one web portal module 168 to facilitate access and exchanges in a controlled manner; and the DP device 146 has a controller 170 and memory 172 with OS 174, NFT mining module 176 and data access module 178.

It will be appreciated that these respective devices can be realized in substantially any suitable fashion, so that these functional blocks represent one way in which these can be physically manifested. Other configurations can be used including additional or other hardware/software, but such has been omitted for purposes of simplicity of illustration. Other entities such as the KYC Provider 122 (FIG. 2) may utilize a similar type device with appropriate capabilities to interact with these devices via the network 148.

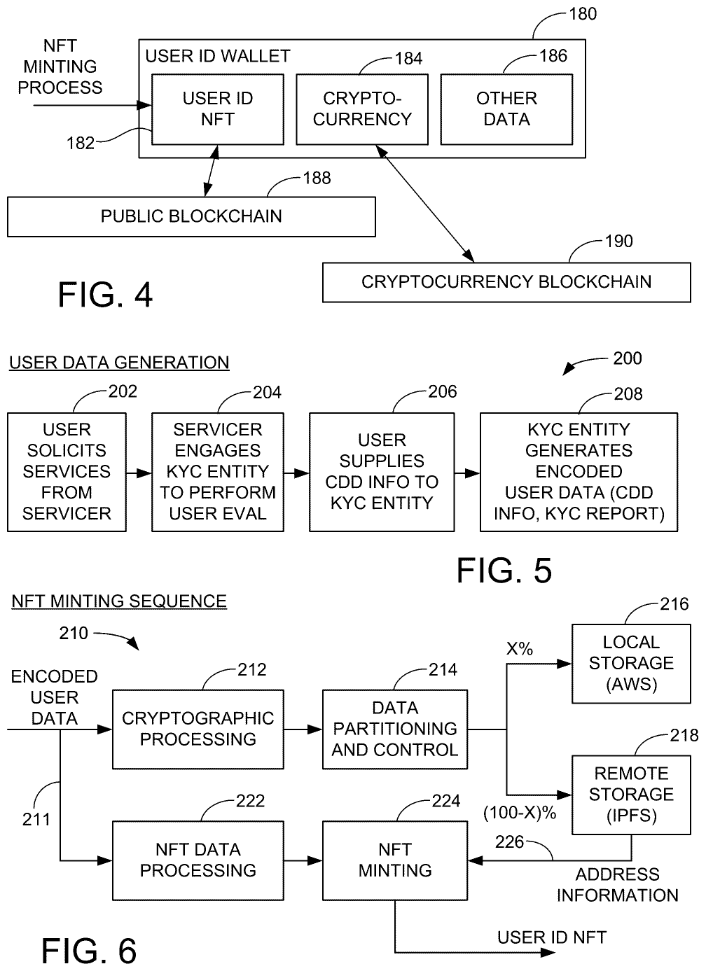

FIG. 4 depicts a user ID wallet 180 that is utilized in the environment 100 of FIG. 1 in some embodiments to protect and control access to the user data associated with the User 102. The user ID wallet 180 corresponds to the user ID wallet 158 in FIG. 3 and can be substantially any type of digital/electronic wallet with the capability of storing and permitting access to a user ID NFT 182 minted by the Data Provider 106 as described herein. The wallet 180 can optionally store other electronic elements as well, including cryptocurrency information 184, other metadata 186, and so on.

As discussed above, the user ID NFT 182 is stored on a public blockchain 188 to ensure the non-fungible characteristics of the NFT and provide the necessary accessibility by other parties (e.g., the Servicer 104, etc.). A cryptocurrency blockchain 190 can facilitate electronic cryptocurrency-based transactions among the entities as desired in conjunction with the user data verification provided by the NFT 182. While separate blockchains are illustrated, such is merely illustrative and is not limiting. In another embodiment, the Data Provider 106 provides a cryptocurrency suitable for transactions of the type carried out between the User 102 and the Servicer 104, and as desired the NFT 182 and cryptocurrency 184 can be maintained in the same blockchain.

FIG. 5 is a sequence flow diagram 200 illustrating operation of aspects of the hardware system 140 depicted in FIG. 3 to generate the user data to be protected by the system. As discussed previously, some embodiments include sequential operations including the solicitation, by the User 102, of services from the Servicer 104, as shown by block 202. As this is a new relationship, the Servicer 104 engages the KYC Provider 122 (FIG. 2) to perform the required IDV processing to evaluate the User at an appropriate investigation level, block 204.

As part of this processing, the User 102 (or responsible human agent thereof) supplies CDD data and documents as required to the KYC Provider 122, block 206. Depending on the level of investigation, this may include personally confidential, proprietary and sensitive information of substantially any type as discussed herein.

To give a concrete example, the CDD data/documents supplied by the individual may include name, address, DOB, social security number or other governmental ID values, driver's license information, passport, residency history, income, asset information, employment information, family information, bank statements and accounts, health history data, and so on.

As can be appreciated, this information can be conveyed in a number of ways including verbally or electronically. Some of this information may involve the filling out of online forms, whereas other parts of this information may be supplied by providing physical documents or images of the same. Other forms of data and formats may be used. Regardless, these and other forms of data and documents constitute personal data (CDD data/documents) protected by the system and used by the Servicer to verify the identity and status of the individual associated with the User 102.

At block 208, the KYC Provider 122 performs the necessary investigation and outputs the user data. As described above, this may include the CDD data/documents originally supplied by the User 102 as well as an associated KYC Report that provides data, information and analysis from various third party databases and other sources based on the information supplied in the originally supplied data. The resulting user data can be in substantially any format. In some cases, the user data may be encoded and provided in a zip protected file format. Various other types of encoding, encryption and cryptographic processing can be utilized to protect the finally processed user data prior to transfer to the Data Provider 106.

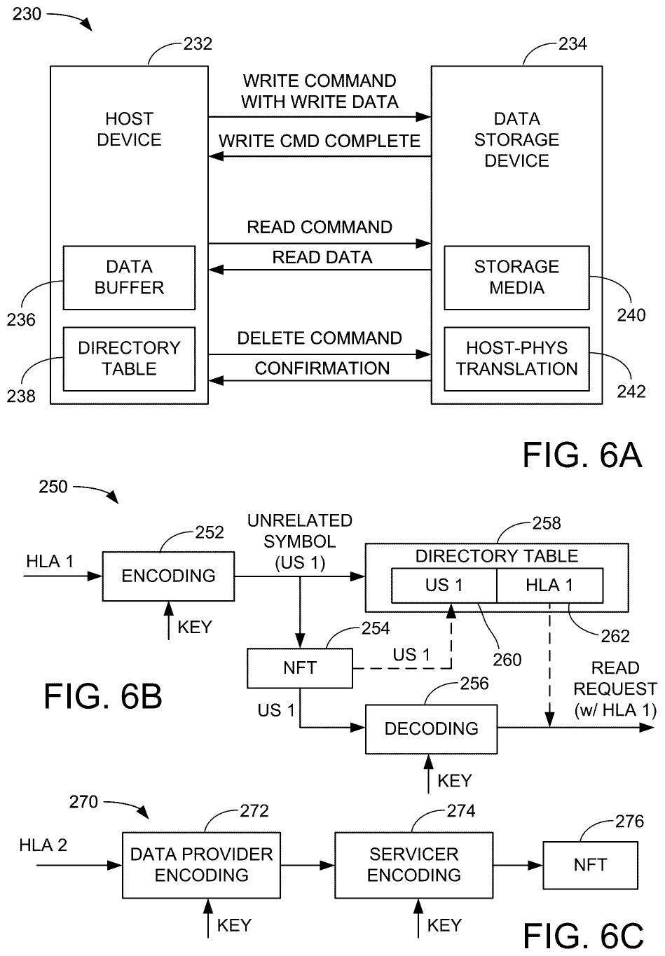

FIG. 6 is a functional block diagram of processing circuitry 210 utilized by the Data Provider 106 to process and store the user data and mint the user ID NFT in some embodiments. Other arrangements can be used. It will be appreciated that the circuitry 210 generally corresponds to the circuitry 112 in FIG. 1 and the elements 176, 178 in FIG. 3.

The encoded user data is supplied via a secure link or other transport mechanism from the KYC Provider 122 as shown at path 211. The data are subjected to lossless encoding using cryptographic processing block 212 to provide one or more suitable levels of data encoding protection upon the user data using one or more suitable cryptographic functions. In some embodiments, a base 64 algorithm scheme is applied and the data are converted into a string format (e.g., a single long number/character sequence which, when decoded, returns all of the data elements in the originally supplied user data provided via path 211). Conversion of the data to string format is particularly suitable but is not necessarily required, as other forms of data arrangement may be used as desired.

A data partitioning and storage control block 214 next partitions (divides) the formatted user data into multiple components. While presently preferred embodiments use two components, this is not limiting as the formatted user data can be separated into any number of components as noted above, so long as there is insufficient content in each component such that any part of the personally identifiable information in the user data cannot be reconstructed without retrieval and combination of all of the components. Exemplary data partitioning strategies to meet these and other requirements are discussed more fully below.

Continuing with FIG. 6, a first portion of the user data corresponding to X % of the total bits therein is directed to local storage 216, and the remaining second portion corresponding to (100-X) % of the total data bits in the formatted user data is directed to remote storage 218. As discussed above, some embodiments set X=25 so that 25% of the user data are stored locally and 75% are stored remotely, although other respective percentages can be used.

Moreover, as noted above the local storage 216 in this example are AWS servers provided contractually to the Data Provider 104 under a prior agreement with AWS, and the remote storage 218 is the IPFS negotiated using a suitable IPFS service (again, arranged via separate agreement with the Data Provider 104). These are not necessarily required, as any number of other arrangements can be utilized, including the provision and maintenance of servers or other data storage capabilities directly or indirectly by the Data Provider.

The circuitry 210 performs additional, parallel data processing of the input encoded user data to generate the user ID NFT 182 (FIG. 4). This can include processing of the input encoded user data by an NFT data processing block 222, followed by the actual minting of the NFT by an NFT minting block 224. While not limiting, in at least some cases there will be no portion of the user data within the NFT itself. However, data associated with the IDV processing can be extracted by block 222 and incorporated into the NFT by block 224. Address information associated with the storage of the user data in the remote storage 218 is provided via path 226 and is also included into the minted NFT.

FIG. 6A provides a functional block representation of a data storage system 230 to better illustrate aspects of the aforedescribed operation of the circuitry 210 in FIG. 6 to store the user data and mint the NFT. FIG. 6A shows an upstream host device 232 in communication with a downstream data storage device 234. For clarity, the host device 232 can correspond to the data partitioning and control circuitry 214 and the data storage device 234 can correspond to the remote storage 218. More generally, these elements can take any number of forms in the practice of the various embodiments described herein. The host device 232 may include a data buffer 236 and a directory table 238; the storage device 234 may include non-volatile storage media 240 and a host-physical address translation layer/table 242.

As will be recognized by those skilled in the art of data storage, an upstream host device such as 232 usually identifies data to be stored by a downstream data storage device such as 234, and issues a write command along with the write data to the storage device. The host will normally identify the write data using a data storage address such as a higher-abstracted host-level addressing scheme. Examples include logical addressing (such as logical block addresses, LBAs), virtual addressing, key-value addressing, physical addressing, object storage, content-based addressing, etc.

The write data may be arranged into a series of fixed sized blocks (e.g., 4096 bytes, etc.) each with a separate host-level block address, but this is not necessarily required. For example, object storage systems may provide the data as a single object, and the storage device subsequently arranges the input data into blocks for management and storage within the storage device media. Storage to the IPFS will result in the generation of a content-based address based on cryptographic processing of the content of the stored data, and the content-based address is thereafter used as the host-level address (e.g., the data storage address) to access the data.

Whatever addressing scheme is used, most modern systems operate such that the host 232 identifies the data to be stored by the storage device 234, and issues a write command and a transfer of the write data to the storage device, so that the write data are transferred from the buffer 236 to the media 240, as shown in FIG. 6A. The data storage address is either supplied as part of the write command or is returned as part of the write operation (IPFS).

A subsequent read command is used to retrieve the previously stored data by presenting the same data storage address by the host 232 to the storage device 234, after which the storage device 234 returns the requested data such as from the storage media 240 back to the data buffer 236.

The stored data may be copied, replicated, moved, etc., but sufficient metadata are maintained (e.g., layer 242, etc.) by the storage device 234 to ensure the ability to retrieve the data upon presentation of the host-level address. As desired, a delete command can be issued to expressly delete the data from the storage device 234. While the data may persist in memory, the associations are removed, the data are marked stale, and will eventually be deleted (garbage collected) to free up that memory space for the storage of new data.

Referring again to FIG. 6, it follows that provision of the host-level address 226 from the IPFS in the NFT in an unprotected form would undesirably allow anyone with access to the NFT to access the component stored to the IPFS remote storage system 218. Accordingly, FIG. 6B provides a processing circuit 250 in which a first host-level address (HLA 1) is encoded by an encoding circuit 252 to output an unrelated symbol (US 1) which is then stored to an NFT 254 as encoded address information. The encoding can take a variety of forms, including encryption or other cryptographic processing using an encryption key or other input, although other forms of encoding can be used.

Thereafter, to access the HLA 1 address and hence, recover the stored user data component, a decoding circuit 256 can be utilized to reverse the encoding of the encoded address information from the NFT 254.

Alternative or additional processing can be carried out as desired. In FIG. 6B, a directory table 258 can associate the encoded address information (260) with the original unencoded HLA 1 address (262) so that, upon access to the NFT, the output HLA 1 can be located and used. This can provide additional layers of protection in the event of inadvertent or malicious destruction of the key used for the encoding and decoding operations.

FIG. 6C shows a multi-level encoding scheme in which another host-level address (HLA 2) is subjected to a first level of encoding by the Data Provider 106 using an encoding block 272, followed by encoding of the first-level encoded address information by the Servicer 104 to generate second-level encoded address information, which is returned to the Data Provider 106 for inclusion in an NFT 276.

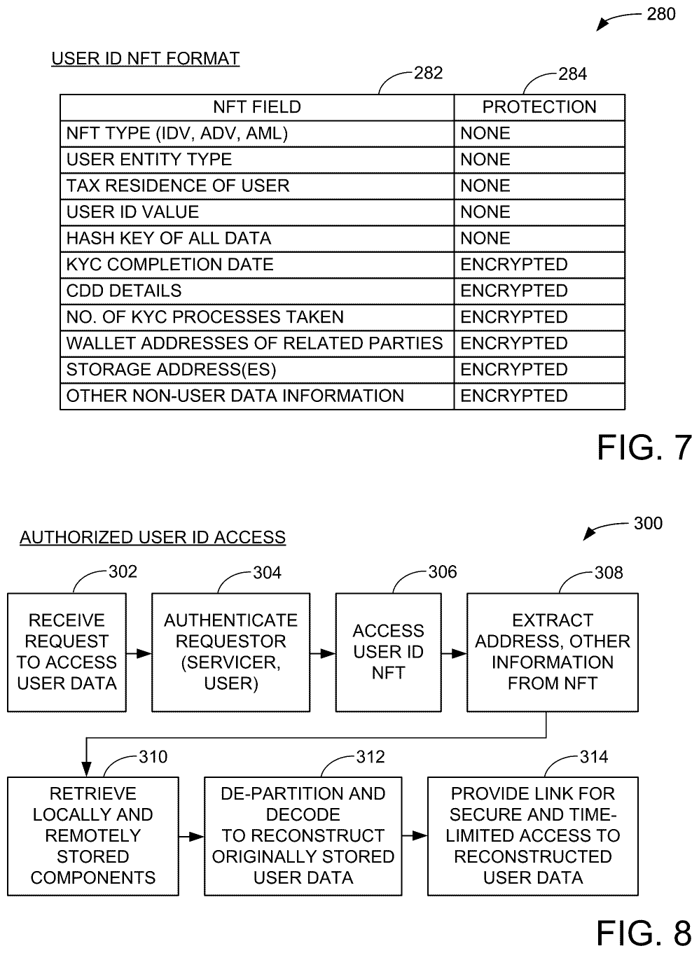

FIG. 7 provides an exemplary format 280 for the user ID NFT as variously discussed above in accordance with some embodiments. Other formats can be used as desired, including tailored formats for a particular transaction, type of transaction, particular group of entities, etc.

The NFT format 280 generally includes a number of fields 282 each containing various types of data as indicated. A protection field 284 indicates the status of the data, namely, whether the data are protected (such as via encryption) or whether the data in the NFT are not protected (e.g., not encrypted). Unprotected data allows any interested party accessing the NFT to access the associated data without the need for further processing. While it is contemplated that at least some of the data in the NFT will be protected, it will be appreciated that all, some or none of the data in the NFT may be either protected or unprotected under different embodiments.

FIG. 7 is largely self-explanatory, but a brief review shows that NFT Type can identify the level of investigation that was carried out during the IDV processing. This can include, but is not limited to, an indication that the NFT is an IDV, ADV or AML type NFT as described above. Other forms of NFT classification can be used.

The User entity type can indicate whether the User 102 described by the NFT is an individual, a corporation, or some other entity. If not an individual, the type of entity may be provided (e.g., domestic corporation, limited liability company, etc.). The tax residence of the user may be shown (e.g., Delaware, USA, etc.) but not the name of the user (at least in this embodiment). A unique ID value assigned to the User 102 may be incorporated, provided this is separately assigned by the present system; using a government issued ID value (SSN, driver's license, Tax ID, etc.) may run afoul of the applicable regulations. As desired a hash value (e.g., a HAMC verification code, etc.) can be utilized to further ensure security. For example, a hash value is generated for some or all of the data within the NFT to ensure the subsequently returned data correspond to the originally stored data.

While not limiting, at this point it will be noted that hash values are generated at appropriate points throughout the system operation to verify that the originally stored data are being returned in identical form. As discussed below, these hash values can be generated for data stored within the respective NFTs, as well as for the data components stored to the various memory storage locations. The hash values may be generated using a suitable hash function (such as a SHA-256 or MD5) to generate a one-way cryptographic hash value, or digital fingerprint. The hash value may be stored with the data as well as in a location separate from the data. Upon the subsequent retrieval (or transmission) of the data, a new hash value may be calculated on the received data and compared to the previously generated hash value to ensure the received data remains unchanged. Various other forms of cryptographic processing may be used as required.

The foregoing fields are indicated as readable. Other information in a readable form may be used as well, provided the MLR and privacy requirements are met.

The protected (encrypted) data shown in the format 280 in FIG. 7 can include the completion date of the KYC Report; various CDD details; and the total number of KYC or other processes (incremented each time and updated). The wallet addresses of other parties may describe other individuals who are also stakeholders in the organization if the User 102 is a corporation or other non-natural person. The storage address information includes the encoded address information of the host-level addresses used to store one or more of the portions (components) of the user data.

FIG. 8 is an authorized user data access routine 300 carried out in accordance with some embodiments to summarize the foregoing discussion with regard to providing authorized access of the user data to an authorized party, such as the User or the Servicer.

Initially, the Data Provider 106 receives a request to access the user data stored herein at block 302. Normally, an authentication operation may be carried out to authenticate the request is from an authorized party using any number of known authentication mechanisms, block 304.

Once authorization is confirmed, access of the User ID NFT is carried out at block 306 to recover the data stored therein, including but not necessarily limited to the encoded address information, block 308.

The encoded address information enables the Data Provider 106 to decode the address information and use this to retrieve the various components, block 310, to de-partition and reconstruct the originally stored user data, block 312, and then provide access through the use of a secure communications link over a network of the reconstructed user data to the authorized party, block 314.

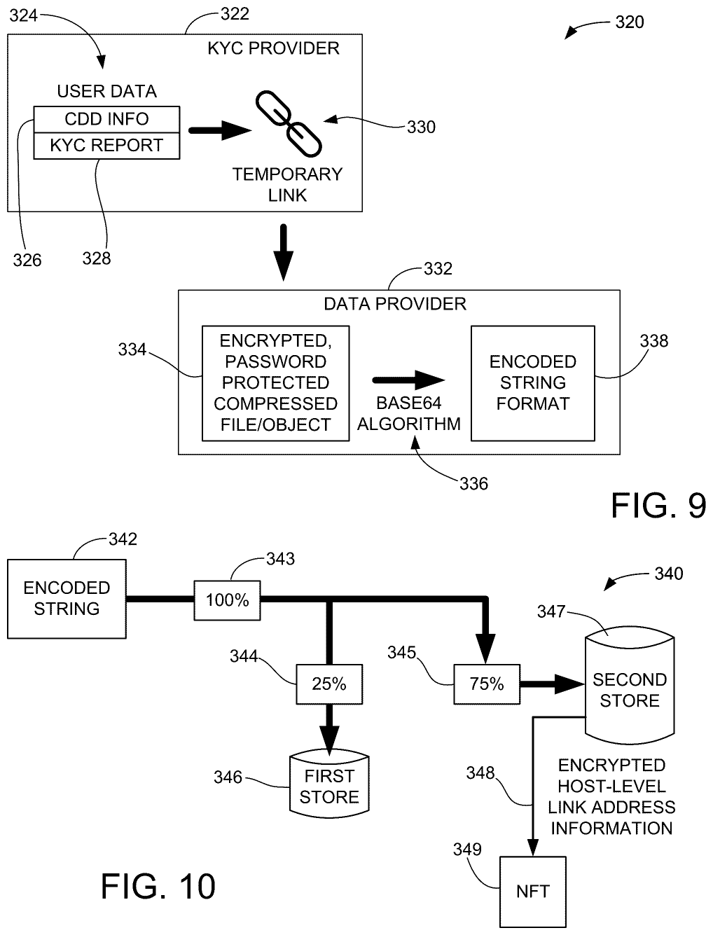

FIGS. 9-13 provide further details regarding aspects of the foregoing processing. FIG. 9 illustrates aspects of a data transfer system 320 to show a transfer from a KYC Provider 322 (corresponding to the KYC Provider 122 discussed above) to a Data Provider 324 (corresponding to the Data Provider 106 discussed above).

The KYC Provider 322 assembles a set of user data 324 which, in this example, includes CDD Info 326 supplied by the User and a KYC Report 328 obtained during the IDV processing. This data set is encoded and transferred, via a temporary secure communication link 330 to the Data Provider 332. The received encoded user data 334 may have various levels of encoding including encryption, password protection, and compression. The encoded data 334 are subjected to additional processing such as described above in FIG. 5. While not limiting, in some embodiments a Base 64 or other algorithm is applied to place the user data into an encoded string format 338. As will be recognized, a string format converts a sequence of bits into a succession of characters or other symbols. Multiple separate files, objects, images, etc. can be successively incorporated into a single string.

FIG. 10 shows a processing circuit 340 that takes an encoded string 342 such as from FIG. 9 and partitions the same for storage. As shown in FIG. 10, 100% of the string is represented at 343; this is respectively partitioned into a first component (portion) 344 and a second component (portion) 345 for respective storage in a first memory 346 at a first storage address thereof and a second memory 347 at a second storage address thereof. An encrypted host-level address for the second memory 347 is provided for inclusion in an NFT 348 as described above. It will be appreciated that the user data 343 can be divided into more than two (2) components (e.g., three portions, five portions, etc.) as desired, and each portion can be separately stored in memory such as the same or different memory locations as shown in FIG. 10.

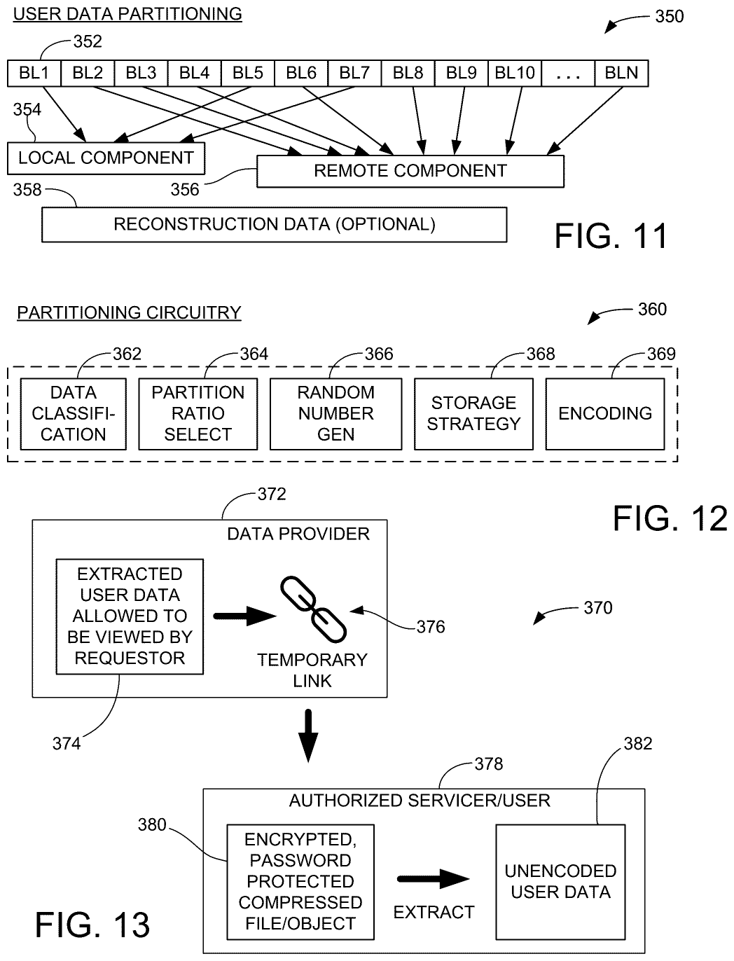

FIG. 11 shows operation of partitioning circuitry of the Data Provider 106 in accordance with further embodiments to carry out partitioning of a user data string 352 such as discussed in FIGS. 9-10. In FIG. 11, the string 352 is made up of a succession of blocks BL 1 through BL N. Each block constitutes one or more bits in the string, and can constitute an arbitrary number of bits (e.g., 100 bits), a single character, multiple characters, or some other suitable granularity.

An interleaving process is utilized to respective accumulate the respective blocks in the string into a respective local component 354 and remote component 356. Using the example from FIG. 10, assume that nominally 25% of the overall user data are to be placed into the local component 354 for storage in a first memory and nominally 75% of the overall user data are to be placed into the second memory. As such, there are a number of ways in which to accumulate these respective sets of blocks.

One approach is to establish the associated ratio of blocks (e.g., 1:3) so that for every one block placed into the local component 354, three blocks will be placed into the second component 356. In some cases, the first 25% of the string is directed to the local component 354 and the remaining 75% is directed to the remote component.

In another approach, every fourth block is placed into the local component 354, so that, as shown in FIG. 11, BL 1 is placed into the first component and subsequent blocks BL 2 through BL 4 are placed in the second component, after which BL 5 is once again placed in the first component and so on. This provides an effective interleaving strategy with nonconsecutive blocks in both components.

Still more complex interleaving techniques can be used such that random number generation or other techniques are used to arbitrarily select blocks for inclusion in the respective components, provided that the overall ratio (e.g., 1:3, etc.) is maintained. For more complex ordering, separate reconstruction data 358 may be generated and included to facilitate the reconstruction process.

Further embodiments generate hash values for each of the components based on the content of each component, and store the hash values as part of the components for subsequent verification. This can be carried out in a number of ways. In some embodiments the component data are hashed and the hash value is appended thereto and the resulting data set is encrypted to provide the final component for storage. Other embodiments store multiple levels of hashes, either with or without the stored components. Still further embodiments retrieve the data, generate a new hash value based on the retrieved data, and compare this to the stored data to verify the data have not been tampered with or otherwise modified. These and other cryptographic verification techniques are well understood by those skilled in the art and can be implemented as desired. Such hash values can be viewed as forming at least a portion of the reconstruction data 358.

FIG. 12 shows partitioning circuitry 360 that can be used in some embodiments to facilitate the partitioning of the user data into multiple components such as in FIG. 11. The circuitry 360 can include data classification circuitry 362 to classify the different parts and types of data; for example, an image may be partitioned differently than a text file, etc. to enhance data security. A partition ratio selection circuit 364 selects a suitable ratio for the respective components. Substantially any ratio of data can be used, provided the personally identifiable user information cannot be reconstructed without the use of all of the components.

A random number generator (RNG) 366 may be useful in some embodiments to enable randomness and increase entropy in the respective components. A storage strategy block 368 establishes an overall strategy based on the requirements of a given application, and an encoding block 369 provides the requisite encoding (including that needed for reconstruction of the originally presented user data).

FIG. 13 shows aspects of another data transfer system 370 to show a transfer from a Data Provider 372 (corresponding to the Data Provider 106 discussed above) to an authorized party 378 (such as corresponding to the User 102 or Servicer 104 discussed above).

The reconstruction of user data by the Data Provider 372 includes formatting the data into a protected form as shown at 374. These data are made available via a secure communication link 376 to the authorized party 378 for receipt in a protected form as shown at 380. As before, the accessed data can be encrypted, password protected, compressed, as well as protected in other suitable ways as desired. The data are extracted to provide the unencoded user data 382.

As noted above, not every party is entitled to all information, and different requests may result in different aspects of the user data being supplied. For example, a verification of identity may require less evaluation than a verification of funds, etc. Accordingly, the system can operate to provide various levels of verification, such as by minting separate NFTs for the User at different levels (e.g., the IDV NFT, the ADV NFT, the MRL NFT described above). Each of these may have different levels of user data (e.g., different levels and types of CDD Info and KYC Reporting information, etc.), and each can be separately processed and stored as described above. In this way, the requesting party can thereafter specify which level/type of user data it wishes to access, and the Data Provider can operate accordingly to provide controlled access to the appropriate level of user data.

The foregoing embodiments have contemplated the user data as constituting a set of data from a variety of sources (including user supplied CDD information, KYC Reports from third party verification sources, etc.). As noted above, the user data is not so limited and instead can take any desired form. In another embodiment, the user data is characterized as a certificate that has been issued to the User that establish certain credentials for the User (e.g., a degree conferred by an institution of higher learning, a membership or certificate of good standing issued by an appropriate authority, etc.). In this case, the foregoing processing is essentially the same, with the user data being protected as before. In this case, the user data NFA can be fairly characterized as a certificate NFA for the associated User.

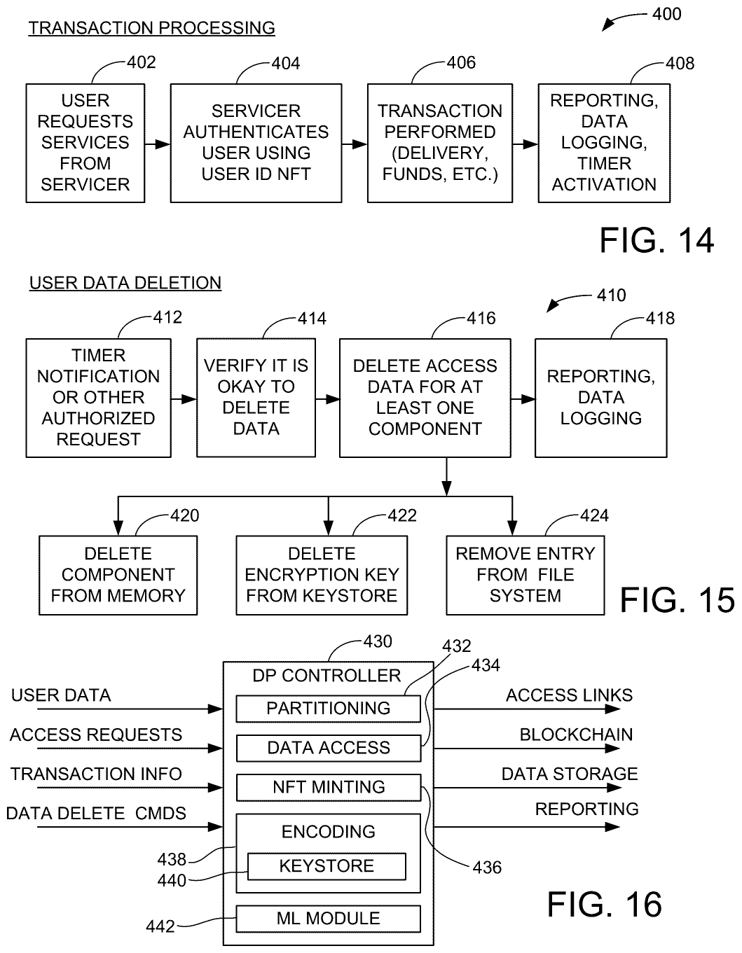

FIG. 14 shows a transaction processing routine 400 that can be carried out using the various embodiments described above. For purposes of providing a concrete example, it will be contemplated that the User 102 is operating a commercial shipping vessel enroute to a destination port, and desires to enter into a transaction with the Servicer 106 to purchase a significant amount of fuel at an intermediate depot.

As such, the routine 400 commences at block 402 with the User 102 requesting services (e.g., delivery of fuel) from the Servicer 104, either immediately or in the near future. The User is verified (authenticated) at block 404 using the appropriate NFT(s) and the evaluation of the user data provided by the Data Provider 106. The electronic nature of the system allows fast and efficient verification of the User and, as required, the funds to be used in the transaction.

The transaction is thereafter carried out at block 406. This may include an electronic portion (e.g., an electronic transfer of funds, including but not limited to cryptocurrency) as well as a physical portion (e.g., several hundred thousand gallons or more of fuel are pumped into the storage tanks of the shipping vessel at the depot).

While not necessarily required, it is contemplated that the transaction at block 406 will result in a number of follow up documentation and data logging operations, as represented at block 408. As desired, non-sensitive details of the completed transaction can be documented in a blockchain or other data reporting system. The Data Provider 106 may be notified with some or all of these data for tracking purposes; in some cases, the Data Provider 106 may store these records on behalf of the Servicer 104.

Another aspect of the operation of block 408 is that a timer function may be initiated as a result of the transaction. It will be recalled that at least under certain MLR requirements the Servicer is required to maintain certain user data for a period of time after the completion of the transaction, such as for five (5) years, etc. As such, the Data Provider 106 may establish and track this time period and ensure that the user data remains available for access for the applicable time period.

FIG. 15 shows a user data deletion routine 410 carried out in accordance with further embodiments. It is contemplated that this will be carried out at the conclusion of the applicable time periods discussed above in block 408, or under other circumstances where the Data Provider 106 is required to delete or otherwise remove the user data from the system.

The routine commences at block 412 where a timer notification or other authorized request (including a privacy request under the GDPR, etc.) is received for selected user data protected by the system. A verification operation is carried out at block 414 to determine whether the data can be destroyed, or needs to remain available under other competing regulations (such as MLR regulations, etc.). In some cases, some of the user data will be able to be destroyed, while other parts of the user data may need to be retained. Such data bifurcation and reprocessing can be readily accommodated by the present system.

Once it is determined that a set of user data should be deleted, the flow continues to step 416 where active measures are taken to delete the data. This may involve deleting the access to at least one component of the user data, since as described above, the entire user data set is effectively destroyed if all of the various components (portions) cannot be recovered. Suitable logging and other reporting operations are thereafter carried out at block 418 to confirm and report the data deletion.

Various alternative approaches to the deletion of the user data are shown in FIG. 15. These can be carried out separate or in combination. Block 420 provides for the deletion of one or more of the components from memory. For example, a command (such as in FIG. 6) can be issued by the system to the appropriate server or other memory storage system to delete the associated component. Upon confirmation of the deleted component, the user data are no longer available. It is possible to even delete data at an IPFS node through the issuance of a data delete command, although the data may still persist at distant nodes for a time until the data are data collected.

Block 422 provides another mechanism for component deletion in which one or more encryption keys (or other control data) are deleted. Using the examples in FIGS. 6B and 6C, the deletion of the encryption and decryption keys prevents the identification of the appropriate host-level address necessary to retrieve the data.

Block 424 provides another related mechanism in which the information relating to the stored data is removed from the file system, thereby eliminating the presence of the system and the ability to subsequently retrieve the data. Other data deletion mechanisms can be employed as required.

FIG. 16 shows a Data Provider (DP) controller 430 operative to carry out the various functions described above in further embodiments. It will be understood that the DP controller 430 generally corresponds to the data management mechanism 112 in FIG. 1, the modules 176, 178 in FIG. 3, the processing circuitry 210 in FIG. 5, the partitioning circuitry 350 in FIG. 12, and so on. The DP controller 430 can be realized in hardware and/or software/firmware, and can be carried out by a single device, a combination of devices, or a distributed network of devices as required.

The DP controller 430 carries out the various features and functions based on a number of inputs supplied to the controller, and generates various outputs to other aspects of the system. The inputs can include but are not limited to user data, various access requests, transaction information, and data deletion commands. The outputs can include but are not limited to providing access links, interactions with one or more blockchains, transferring data to and from various data storage systems, and providing various reporting functions.

The DP controller 430 can be characterized as including a partitioning circuit 432, a user data access circuit 434, an NFT minting circuit 436, and an encoding circuit 438 (including an associated keystore 440 as a secure memory location for keys and other encryption/crypto elements). As desired, the DP controller 430 can further include a machine learning (ML) module to apply machine learning and artificial intelligence (AI) techniques to evaluate and improve system processing.

The various embodiments described herein empower a User to preserve anonymity and privacy while enabling a Servicer to be fully KYC compliant with respect to the User. As described previously, the system processes the User's data, encrypts it and stores the location of the encrypted data at the user's wallet via one or more NFTs or similar digital assets. Each wallet can be verified, freely transferred, and owned by one or more individuals and/or entities. In further embodiments, accessing a web portal can allow verified user identification to access online services without the need for the user to supply email, phone number, or other information including multi-factor authentication methods to verify the user.

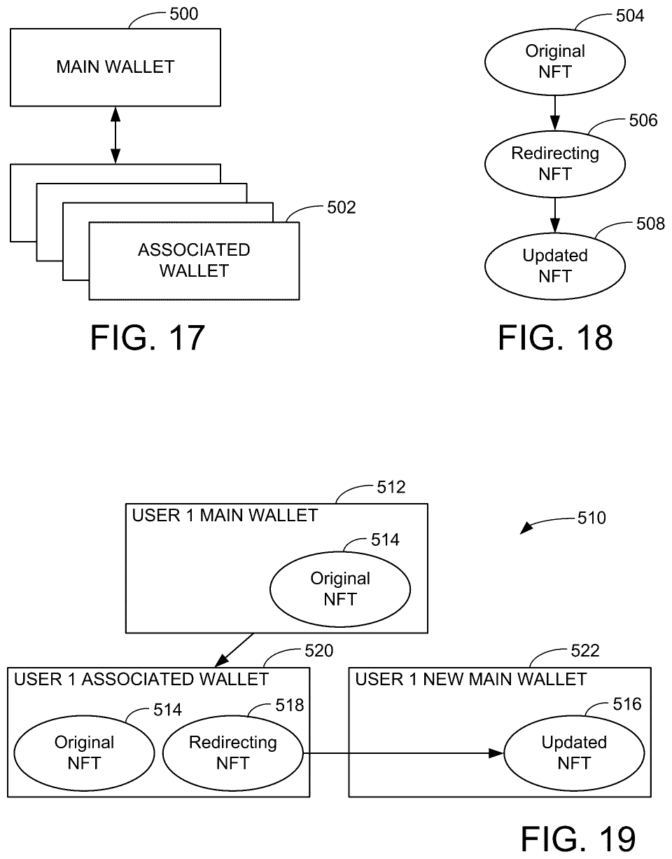

FIG. 17 shows different types of wallets that can be generated and used by a User in accordance with further embodiments. Generally, there are two main types of available wallets: a main wallet as shown at 500, and one or more associated wallets, as shown at 502. The main wallet stores an NFT with encoded storage location data as described above to link to the storage of the encrypted portion of the user data. Each associated wallet stores redirecting links to other associated or main wallets. The main wallets 500 and associated wallets 502 maintain a history as the protected user data are updated, or other system changes occur over time.

Every individual or corporation will set up a main wallet address, and the main wallet 500 at this address will include, inter alia, the storage link information for at least a portion of the most up-to-date user data. The associate wallets 502 are used to redirect to the updated user information. While not limiting, it is contemplated that main wallets 500 are not transferrable to other Users, but the associated wallets 502 may be transferred to other Users under certain controlled circumstances.

It will be recalled that NFTs, and other non-fungible digital assets, are non-fungible; that is, such are indelibly recorded and maintained on a blockchain (or other indelible structure) and cannot normally be changed or updated. For clarity, reference to storing an NFT to a wallet will be understood in this context (e.g., the wallet links to the associated NFT on the blockchain or other indelible structure). The user data referenced by a given NFT as minted herein can thus be viewed as a snapshot of the user data at a given time. Updates to the user data are thus handled using the wallets 500, 502 in FIG. 17 as well as by the various types of NFTs shown in FIG. 18.

FIG. 18 shows different types of NFTs that can be minted for use in the various wallets 500, 502. These different types of NFTs include original NFTs 504, redirecting NFTs 506, and updated NFTs 508.

Generally, only one original NFT 504 can be in a main wallet 500 at a time. However, if this original NFT 504 is updated, such as by the user performing an updated KYC report process, etc., then an updated NFT 508 will be generated showing the updated information, and a redirecting NFT 506 will be generated to point from the original NFT 504 to the updated NFT 508. The redirecting NFT 506 may be stored in an associated wallet 502 that points to the main wallet 500.

A number of alternatives are available. In some cases, it is possible to configure the system such that the updated NFT 508 can be added to the existing main wallet 500 so that the existing main wallet has both the original NFT 504, the updated NFT 508 and, as desired, the redirecting NFT 506 that links the original NFT 504 to the updated NFT 508.

However, various other embodiments contemplate that there will only be one main wallet 500 for each User, and that one main wallet will store the most up-to-date NFT information. Thus, each wallet in this scheme can only store one original or updated NFT 504, 508 for a given User. This allows each wallet/NFT combination to be a separate and verifiable digital asset with a single active NFT that points to the most up-to-date user data for that User.

In this latter case, an existing old main wallet can be replaced by another new main wallet, and the existing old main wallet can become an associated wallet. As an associated wallet, this existing old main wallet, with the addition of the redirecting NFT 506, can be transferred to a new owner and potentially become the new main wallet for this other User by minting an updated NFT 508 associated with this other User.

This processing can be understood with a review of FIG. 19. In FIG. 19, a selected user (User 1) submits to the various processing described above and is provided with a main wallet 512, in which is stored a link (on the block chain) to an original NFT 514. At this point, if nothing further takes place, User 1 can continue to present this wallet 512 with the verified information supplied by the original NFT 514 for processing as described above, and the wallet 512 is the sole wallet (main wallet) used by User 1.

However, at some point in the future, User 1 may decide, or be required, to obtain updated user data. For example, the CDD information (e.g., passport, driver's license, certificates, etc.) may expire, change, be updated, be appended, etc., requiring these documents to be renewed, updated, etc. In another example, additional levels of KYC Reports may need to be generated, such as a deeper level of verification for AML purposes, and so on.

As such, updated user data (CDD Information and/or KYC Reports) will be processed as described previously and supplied to the Data Provider to mint one or more additional NFTs. These can include an updated NFT 516 that reflects the encrypted storage address for the new user data and one or more redirecting NFTs 518 that point to the updated NFT 516.

In some embodiments, as noted above the User 1 may wish to simply maintain both the original NFT 514 and the updated NFT 516 in the main wallet 512, in which case the updated and redirecting NFTs 516, 518 can be added to the main wallet 512. However, this presents a number of potential issues with regard to providing a tracking mechanism to ensure that the latest NFT is being accessed.

Accordingly, the flow of FIG. 19 provides the main wallet 512 as being converted to an associated wallet 520 and the redirecting NFT 518 is added thereto. The redirecting NFT 518 points to a new main wallet 522 that is generated for User 1, and the new main wallet stores a link for the updated NFT 516. In this way, the various NFTs form a linked-list that points forward to the latest location for the most up-to-date data.

The user (or other party) can access the address of the original main wallet 512, and the redirecting NFT 518 will point to the location of the new main wallet 522 and the updated NFT 516. This allows the history data of the NFT information to be maintained over time. Transfers to different owners can be easily captured and recorded using this mechanism. For example, the associated wallet 516 could be transferred to a new owner (User 2) by generating a second redirecting NFT and a new updated NFT for User 2, while User 1 continues to own and use the new main wallet 520.

Based on the foregoing, it will be observed that at least some embodiments mint both an NFT and produce the corresponding wallet as a concurrent operation. Unlike conventional digital wallets where the wallet is tied to a particular user or device and contents are placed therein or removed therefrom, it is the combination of the wallet and the NFT(s) therein that are transferred and used in the foregoing embodiments.

Hence, each combination of the wallet and the NFT(s) stored therein can be more generally characterized as a blockchain-based pointer record. The blockchain-based pointer record can also be characterized as a non-fungible user ID digital asset (“NFA” or “asset”). It will be appreciated that specially configured wallets and NFTs are particularly suitable assets for use in protecting user data as described herein. However, it will be appreciated that other similar forms of assets can be used, so it is not necessarily required that the assets be described as wallets or NFTs per se.

The blockchain-based pointer record, as variously embodied herein, provides a number of operational features. First, the record is non-fungible and cannot be tampered with, being protected by the blockchain as well as by the encryption/hashing etc. built into the data structure of the record. Second, the record stores one or more pointers to the information on the blockchain to enable the storage address(es) to be accessed to reconstitute the user data. Third, the record stores top level, non-personally identifiable information associated with the user (e.g., UID, entity type, type of KYC processing, etc.) which allows a top level due diligence event to be carried out without the need to access and reconstruct the user data.

The blockchain-based pointer record thus stores the storage address information for the user data (in encoded form on the blockchain), and both encrypted and plaintext payload information (sometimes referred to as a data payload associated with the user). This provides multi-level user identification verification capabilities, in at least some embodiments. A first level of verification allows a requesting party such as a Servicer to access the record and be satisfied that KYC/CDD has been completed sufficiently to proceed with the transaction based on the data payload. A second level of verification allows the requesting party to request the full user data be recovered and examined, by having the Data Provider decode and use the storage address information within the record to access the component(s) from the respective memory locations.

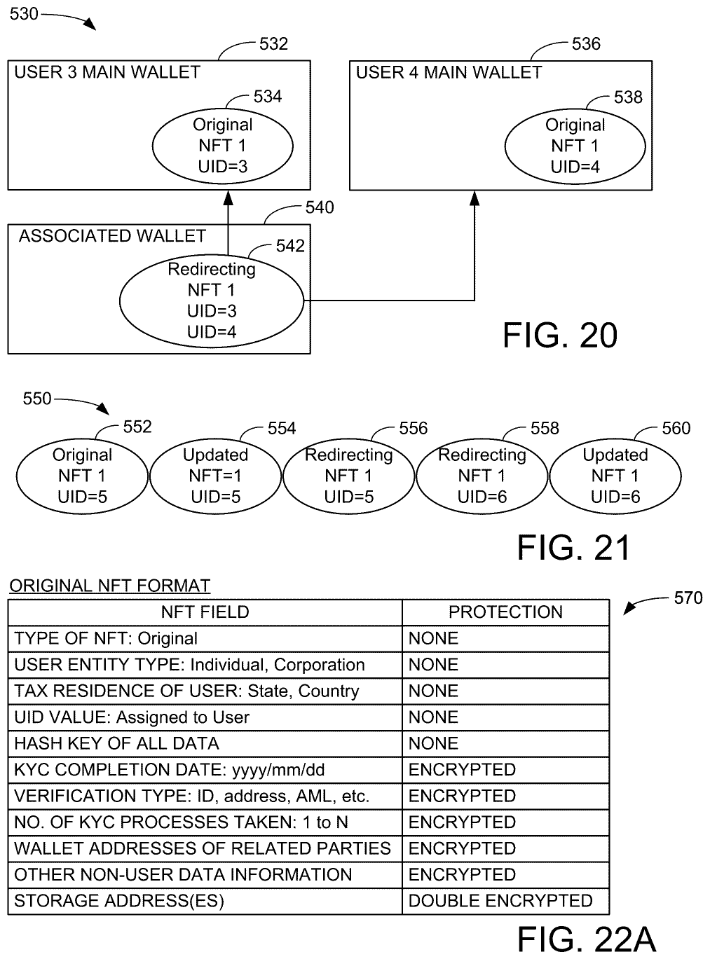

In some cases, an associated wallet (such as 502 in FIG. 17) can have more than one owner. This arrangement is represented at 530 in FIG. 20, which shows a first main wallet 532 of a first physical person (User 3) which stores an original NFT 534 to point to user data associated with that person. A second main wallet 536 is similarly provided for a second physical person (User 4) which stores an original NFT 538 to point to user data associated with that person. For reference the User ID (UID) is set to 3 for User 3 (UID=3) and to 4 for User 4 (UID=4).

An associated wallet 540 is owned by both User 3 and User 4 and stores a redirecting NFT 542 that points to both of the respective NFTs 534 and 538. This type of arrangement is useful in situations where the two persons are related, such as co-owners or partners in a business, related family members, etc. Both persons can access the associated wallet 540, such as by having a copy stored on each user device, a copy stored in an accessible location where each user device can separately gain access to the redirecting NFT 542, etc. Similar redirecting NFTs can be minted as required to transfer ownership of wallets, denote multiple owners within the same company, and so on.

The ownership history of a wallet can be ascertained by examining the various NFTs linked thereto. FIG. 21 shows an ownership history chain 550 that can be reconstructed for a specific wallet. The history chain 550 shows that the wallet was initially the main wallet for a first user (with UID=5), as shown by NFT 552. This user subsequently updated the KYC Report once, as indicated by NFT 554, and then changed and transferred to a new wallet, NFT 556. The user then transferred the old main wallet to a second user (UID=6), as shown by NFT 558, and the second user made this wallet their main wallet, NFT 560. It will be appreciated that the minting dates will be important for all NFTs, and this can be reported as part of the NFT readable information as well as in a separate database used by the Data Provider.

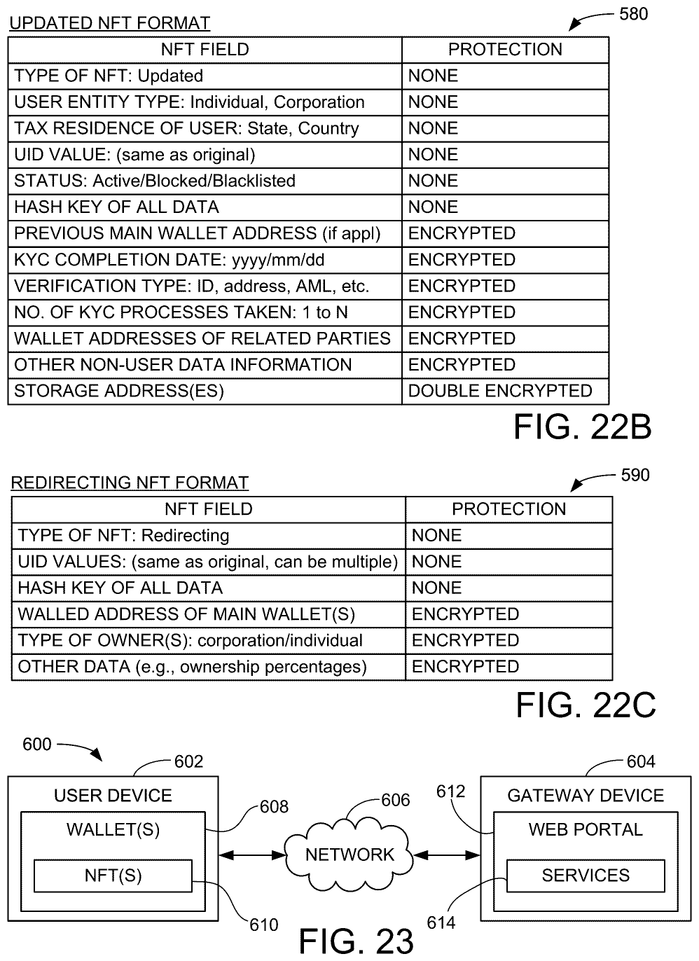

The formats for the different types of NFTs (original, updated and redirecting) can be arranged as required, including as described above in FIG. 7. In further embodiments, each of these different types of original, updated and redirecting NFTs can have formats as respectively shown at 570, 580 and 590 in FIGS. 22A through 22C.

It can be seen that the exemplary formats for the original NFT 570 (FIG. 22A) and the updated NFT 580 (FIG. 22B) are similar, except that the updated NFT includes an additional status field. This can be used to indicate the current assigned status (e.g., active, blocked, blacklisted, etc.). This status will be determined by the Data Provider. The updated NFT 580 also provides an encrypted address for the wallet that was the previous main wallet for the original NFT 570 (or previously updated NFT). While not necessarily required, the storage address location data in the respective NFTs 570, 580 are shown to be double encrypted. That is, the address information is encrypted initially, and then encrypted a second time with the other encrypted NFT data. Other arrangements can be used.

The redirecting NFT 590 (FIG. 22C) can be significantly shorter than the original and updated NFTs 570, 580. Of note is the fact that the NFT/wallet can be owned by multiple owners, so that more than one UID value can be supplied as discussed above in the example of FIG. 21.

As discussed above, a web portal service can be provided by the Data Provider to which a given User can connect their associated wallet. This is generally illustrated in FIG. 23, which shows a connection system 600 in which a selected User connects a user device 602 to a gateway device 604 via a secure connection supplied over/through a network 606.

The user device 602 is shown to store or otherwise access one or more wallets 608 with associated NFTs 610. These are communicated via a web portal 612 which, upon confirmation of the user, allows access to various services 614. It will be appreciated that the wallet(s) 608 and web portal 612 can operate as or with respective software/firmware programming (e.g., apps, smart contracts, etc.) to carry out the various functions described herein.

The portal 612 is managed by the Data Provider and is configured to allow a number of different authorized parties to access a wallet. These parties include authorized administrative personnel (who have the authority to block or otherwise grant access), various Servicers (who as noted above may need to access the user data in order to lawfully proceed with a transaction), and various Users (which as noted above may be one or more individuals, a business entity, etc.).

In some embodiments, once a wallet connection is established, the system may first determine whether the wallet is verified or unverified. If unverified, the presenter (in this case, a selected User) can be subjected to multiple levels of KYC verification, including ID verification, ID and address verification, or ID and address verification along with an AML check. Upon successful completion of the foregoing KYC verification, the wallet will now be classified as verified and the verified wallet becomes the main wallet for the User.

Subsequent connections of the verified wallet to the portal allow the User to carry out a number of operations. These can include: accessing the data stored within the NFT or otherwise available via access, such as the KYC completion date, when the user data can be destroyed (based on the services used), the type or level of KYC processing that has been completed, messages that have been sent to the wallet address, a list of all verified wallets owned by the User, and the authorization or access that the User has to various services.

The User may also be able to carry out other functions as well. These can include requesting a higher level of KYC processing, which will result in the minting of an updated NFT to the existing main wallet. The User can further request other wallets to be verified at this time. The User can also transfer an existing wallet to a new owner, receive ownership of a wallet transferred from another party, request that the user data be deleted, or request that a new main wallet be generated through the minting of an updated NFT.

The transfers of wallets are carried out as discussed above. In some embodiments, upon the User selecting to initiate a transfer of a verified wallet, the Data Provider can operate to provide the User a transfer code that needs to be shared with the receiving party within a specified period of time. The receiving party then needs to connect to the portal with a verified wallet having a different UID and accept ownership using secure processing including the entry of the transfer code supplied to the User.

With regard to the other available options, a request to delete the user data is subject to the data retention requirements discussed previously. In some cases, the system can operate to report to the User the earliest available time/date when the user data can be deleted. The system can be configured to log this request so that, when the time/date arrives, the system proceeds to delete the data (as discussed above in FIGS. 14-15).

The processing on the Data Provider side (via the portal) can be managed using smart contracts or other automated mechanisms that track which wallets are verified, the status of the various wallets, the authorizations that have taken place or that are required to facilitate secure access, and so on. In this way, when a Servicer connects to the system, a check can be performed to ensure that the Servicer has the authority to access the user data. If so, the data are provided as described above including in FIGS. 8 and 13-14.

Finally, further security verification measures can be undertaken to ensure that the party presenting a verified wallet to the portal is authorized to do so. Any number of techniques can be used, including biometric identification that can be facilitated by the user device. For example, fingerprints, facial recognition and other techniques can be used as part of the portal access processing. In one embodiment, multiple data points on a self-image (selfie) taken by a smart phone by the User can be used. AI and/or ML techniques can be used as part of the security processing.

The system as variously embodied herein is highly flexible and can be adapted for use in a number of different operational environments. The various components of the user data can be stored substantially anywhere and by any party, so long as the various components can be accessed and used to reconstitute the user data.

For example, in some embodiments it is contemplated that the User may be provided with a component that is presented as part of the authentication process (such as to the web portal described above) along with other information, so that the component operates as a key to facilitate unlocking of the user data through combination with other components stored elsewhere as described herein. In other embodiments, the Servicer may be provided with one or more components for presentation during user data reconstitution operations.

In further embodiments, the various operational elements described herein can be used with third-party systems such as custodial wallets held by cryptocurrency exchanges or other parties. In this case, the various main and associate wallets can be used as intermediate wallets to facilitate the secure transfer of cryptocurrencies while providing the requisite identity tracking (such as by the so-called Travel Rule regulations for international transfers). Other applications will readily occur to the skilled artisan in view of the present disclosure.

It will now be appreciated that the various embodiments presented herein provide a number of benefits. User data can be safely and effectively stored in such a way that it cannot be accessed without authorization. The partitioning of the user data ensures that multiple data storage requirements can be met, including jurisdictional, availability, security, and ease of destruction (by for example, only destroying a single component to thereby delete the entire set of data).

The use of one or more non-fungible ID digital assets, such as in the form of User ID NFTs and wallets, further provides access levels for an authorized party, such as a Servicer, in evaluating data from the NFT and then, as required, obtaining secure access to greater levels of the user data to facilitate a transaction. The various embodiments thus provide an efficient and effective mechanism for ensuring compliance with all applicable MLR and data privacy requirements.

For purposes herein, the term “personally identifiable information” and the like will be understood consistent with the foregoing discussion to mean any representation of information that permits the identity of a natural person (an “individual”) to whom the information applies to be uniquely determined by either direct or indirect means, and includes any information that can be used to distinguish or trace the individual's identity or is otherwise linked or linkable to the individual to allow unique identification. Examples of personally identifiable information include but are not limited to name, social security number, date and place of birth, mother's maiden name, biometric records, medical, educational, financial, and/or employment information, etc., as well as other examples listed above.

It is to be understood that even though numerous characteristics and advantages of various embodiments of the present disclosure have been set forth in the foregoing description, together with details of the structure and function of various embodiments of the disclosure, this detailed description is illustrative only, and changes may be made in detail, especially in matters of structure and arrangements of parts within the principles of the present disclosure to the full extent indicated by the broad general meaning of the terms in which the appended claims are expressed.

1-16. (canceled)

17. A computerized method comprising:
receiving confidential user data associated with a User into a memory;
partitioning the confidential user data into at least a first portion, a second portion and a third portion;
storing the first portion in a first memory location;
storing the second portion in a different, second memory location;
providing the third portion to the User for storage, by the User, in a different, third memory location;
encoding a memory storage address associated with a selected one of the first or second memory locations to generate encoded address information;
minting a non-fungible asset (NFA) that includes the encoded address information and a non-confidential data payload associated with the User, the NFA associated with a distributed blockchain;
linking the NFA to a digital wallet of the User;
subsequently presenting, by the User, the digital wallet and the third portion, the third portion retrieved from the third memory location;
subsequently accessing the confidential user data by accessing the digital wallet presented by the User, retrieving the encoded address information from the NFA, retrieving the first and second portions from the first and second memory locations, reconstituting a copy of the confidential user data from the retrieved first and second portions and from the retrieved third portion presented by the User, and providing the copy of the confidential user data to an authorized party via a secure communications link; and
permanently destroying access to the confidential user data by at least a selected one of deleting a selected one of the first or second portions from the associated first or second memory location, or deleting by the User of the third component, or destroying an encryption key used to generate the encoded address information stored in the NFA.

18. The method of claim 17, wherein the confidential user data comprises personally identifiable information supplied by the User and a background report on the User supplied by a third party verification provider, and wherein the partitioning of the confidential user data into the at least first, second and third portions comprises a partitioning operation that prevents reconstitution of any of the personally identifiable information from the confidential user data associated with the User from a single one of the first, second or third portions.

19. The method of claim 17, wherein the storing of the first portion in the first memory location and the storing of the second portion in a different, second memory location are carried out by a Data Provider, wherein the first memory location and the second memory location are inaccessible by the User, and wherein the third memory location is inaccessible by the Data Provider.

20. The method of claim 17, wherein the NFA is a blockchain-based pointer record linked to the digital wallet of the User.

21. The method of claim 20, wherein the blockchain-based pointer record is a first record and the digital wallet is a first wallet, wherein updated confidential user data associated with the User are processed to generate an updated, second record with second encoded address information in a second wallet, and wherein a redirecting, third record is stored in the first wallet to redirect to the second wallet.

22. The method of claim 21, wherein the User is a first User, and the method further comprises transferring ownership of the first wallet from the first User to a different, second User while the first User retains ownership of the second wallet.

23. The method of claim 20, wherein the User is a first User, the blockchain-based pointer record is a first record and the digital wallet is a first main wallet owned by the first User, wherein a second blockchain-based pointer record is minted responsive to confidential user data associated with a second User and linked to a second main wallet owned by the second User, and wherein the method further comprises generating an associated wallet that is owned by both the first User and the second User, the associated wallet having a redirecting blockchain-based pointer record that points to each of the respective first and second blockchain-based pointer records in the first and second main wallets.

24. The method of claim 17, wherein the blockchain-based pointer record comprises a non-fungible token (NFT) which stores first information in an unencrypted form, second information in an encrypted form, and a hash value generated responsive to the first information and the second information.

25. The method of claim 17, wherein the encoded address information is an address of remote server memory node at which a selected one of the first or second portions is stored.

26. The method of claim 17, further comprising steps of:
identifying an elapsed time interval during which the confidential user data are to remain accessible;
initiating a timer responsive to the minting of the NFA, the timer associated with the elapsed time interval; and
performing the permanently destroying access step responsive to an indication from the timer of a conclusion of the elapsed time interval.

27. The method of claim 17, wherein the authorized party is a Servicer associated with the User, wherein the confidential user data are reconstituted responsive to a request by the Servicer, and wherein the Servicer uses the reconstituted confidential user data to verify an identity of the User in compliance with a governmental regulatory requirement prior to engaging in a transaction with the User.

28. The method of claim 17, wherein the first memory location is a first storage server physically located within a jurisdiction in which the User is located, and wherein the second memory location is a second storage server physically located outside the jurisdiction in which the User is located.

29. The method of claim 17, wherein the confidential user data are partitioned using an interleaving scheme where blocks of the confidential user data are non-consecutively assigned to the respective at least first and second portions in accordance with a block assignment table, the block assignment table incorporated into and stored with the at least first and second portions.

30. The method of claim 17, further comprising connecting, by the User, the digital wallet to a web portal, the web portal executing a smart contract to reconstruct and access the confidential user data to facilitate access, by the User, of at least one software-based service associated with the web portal.

31. The method of claim 17, wherein the first memory location is a local server and the second memory location is a remote server, wherein the remote server comprises an Interplanetary File System (IPFS) memory node, and the encoded address information is generated by the IPFS memory node.

32. The method of claim 17, wherein the first portion is encrypted prior to storage at the first memory location, wherein the second portion is encrypted prior to storage at the second memory location, wherein each of the encrypted first and second portions are subsequently decrypted to provide the reconstructed user data, and wherein at least one hash function is used to generate at least one hash value responsive to the first and second portions that is subsequently used to confirm the reconstructed user data matches the received user data.

33. The method of claim 17, further comprising storing the encryption key used to generate the encoded address information in a keystore memory, and subsequently destroying the encryption key from the keystore memory.

34. The method of claim 27, wherein the reconstituted confidential user data comprises a Servicer entitled data portion and a User entitled data portion, and wherein the method further comprises granting access, for the Servicer, to the Servicer entitled data portion of the reconstituted confidential user data while preventing access, for the Servicer, to the User entitled data portion of the reconstituted confidential user data.

35. The method of claim 17, wherein the authorized party is the User, wherein the reconstituted confidential user data comprises a Servicer entitled data portion and a User entitled data portion, wherein the method further comprises granting access, for the User, to the User entitled data portion of the reconstituted confidential user data while preventing access, for the User, to the Servicer entitled data portion of the reconstituted confidential user data, and wherein the Servicer entitled data portion is associated with a Servicer and comprises background check information obtained by a third party verification provider associated with the Servicer.

36. The method of claim 17, wherein the confidential user data associated with the User is generated by steps comprising:
supplying, by the User, at least one confidential document having personally identifiable information associated with the User;
generating, by a third party verification provider, a confidential background report based on the at least one confidential document; and
combining the personally identifiable information and the confidential background report to form the confidential user data, wherein a portion of each of the personally identifiable information and a portion of the confidential background report is incorporated into each of the first portion and the second portion.

37. A method, comprising:
generating confidential user data responsive to personally identifiable information supplied by a User and confidential background report information supplied by a KYC Provider based on the personally identifiable information;
using at least one programmable processor of a Data Provider to perform the following operations in response to the generating of the confidential user data:
storing the confidential user data in a computer memory of the Data Provider;
partitioning the confidential user data into at least a first portion, a second portion and a third portion;
directing storage of the first portion in a first memory location;
directing storage of the second portion in a different, second memory location;
directing transfer of the third portion to the User for storage, by the User, in a different, third memory location;
encoding a memory storage address associated with the second memory location to generate encoded address information;
minting a non-fungible asset (NFA) that includes the encoded address information and a non-confidential data payload associated with the User, the NFA associated with a distributed blockchain; and
linking the NFA to a digital wallet of the User;
subsequently presenting, by the User, the digital to a web portal to initiate a transaction between the User and a Servicer; and
using the at least one programmable processor of the Data Provider to perform the following operations in response to the presenting of the digital wallet:
retrieving the first portion from the first memory location;
retrieving the encoded address information from the NFA;
using the retrieved encoded address information from the NFA to retrieve the second portion from the second memory location;
receiving the third portion from the User, the third portion retrieved from the third memory location;
reconstituting a copy of the confidential user data from the retrieved first and second portions and from the retrieved third portion presented by the User; and
providing the copy of the confidential user data to the Servicer via a secure communications link.

38. The method of claim 37, wherein the confidential user data is further partitioned into a fourth portion, wherein the fourth portion is directed to the Servicer for storage, by the Servicer, in a different, fourth memory location, and wherein the copy of the confidential user data is further reconstituted using the fourth portion as supplied by the Servicer.

39. The method of claim 37, wherein the first memory location constitutes a portion of the memory of the Data Provider, and wherein the second memory location constitutes a portion of a memory of a remote server coupled to the memory of the Data Provider via the Internet.

40. The method of claim 37, wherein the digital wallet is a first wallet, wherein updated confidential user data associated with the User are processed to generate an updated, second NFA with second encoded address information in a second wallet, and wherein a redirecting, third NFA is generated and stored in the first wallet, the third NFA providing a link to the second wallet.

41. The method of claim 37, wherein the User is a first User, and the method further comprises transferring ownership of the digital wallet from the first User to a different, second User.

42. The method of claim 17, further comprising steps of:
identifying an elapsed time interval during which the confidential user data are to remain accessible responsive to a governmental record retention requirement, the elapsed time interval equal to or greater than one year;
initiating a timer responsive to the minting of the NFA, the timer associated with the elapsed time interval; and
performing the permanently destroying access step responsive to an indication from the timer of a conclusion of the elapsed time interval.

43. The method of claim 37, wherein the first memory location is a first storage server physically located within a jurisdiction in which the User is located, and wherein the second memory location is a second storage server physically located outside the jurisdiction in which the User is located.

44. The method of claim 37, wherein the confidential user data are partitioned using an interleaving scheme where blocks of the confidential user data are non-consecutively assigned to the respective at least first and second portions in accordance with a block assignment table, the block assignment table incorporated into and stored with the at least first and second portions.

45. The method of claim 37, wherein the first memory location is a local server and the second memory location is a remote server, wherein the remote server comprises an Interplanetary File System (IPFS) memory node, and the encoded address information is generated by the IPFS memory node.

46. The method of claim 37, wherein the reconstituted confidential user data comprises a Servicer entitled data portion and a User entitled data portion, and wherein the method further comprises granting access, for the Servicer, to the Servicer entitled data portion of the reconstituted confidential user data while preventing access, for the Servicer, to the User entitled data portion of the reconstituted confidential user data.
